(19) United States
(12) Patent Application Publication
(10) Pub. No.: US 2014/0068893 A1
(43) Pub. Date: Mar. 13, 2014

(54) DOOR DAMPING APPARATUS AND MANUFACTURING METHOD THEREOF

(71) Applicant: FANG-HSING HUNG, TAIPEI CITY (TW)

(72) Inventor: FANG-HSING HUNG, TAIPEI CITY (TW)

(73) Assignee: E TAI ENTERPRISE CO., LTD., KEELUNG (TW)

(21) Appl. No.: 13/606,227

(22) Filed: Sep. 7, 2012

(51) Int. Cl. E05F 3/10; B21D 51/16

(52) U.S. Cl. 16/52; 29/890.09

(57) ABSTRACT

The instant disclosure relates to a door damping apparatus for connecting to a door and an immobile frame. The door damping apparatus includes a shaft seat, a shaft, a cylinder, a piston, a spring unit, a check valve and a throttle valve. The interior of the shaft seat is formed with a fluid passage and a reservoir to store hydraulic fluid. The throttle valve projects into the fluid passage to adjust the flow of the hydraulic fluid, thus allowing the door to be opened smoothly and gently self closes.

### BACKGROUND

1. Technical Field

The present disclosure relates to a door damping apparatus; in particular, with hydraulics and spring assembly.

2. Description of Related Art

Glass doors are commonly used in public domain and one can usually find the implementation of automatic door returning devices arranged between a door and frame. The installation of automatic door returning devices helps to close the door with a soft ending and reduces the rebounding force. Conventional glass doors are usually hinged to fixed walls or glass panels via some sort of door damping apparatus. The conventional glass doors are equipped with dampers that use either springs or elastic bodies to attenuate the bouncing force and prevent any damage afflicted to the door.

However, conventional elastic bodies or spring dampers suffer from loud noise, unbalanced returning force, and worn parts after repetitive operations. To address the above issues, the inventor strives via industrial experience and academic research to present the instant disclosure, which can effectively improve the limitations described above

### SUMMARY

The object of the present disclosure is to combine the hydraulic conduit and spring assembly to a door damping apparatus. The apparatus enables a door to self-close in a smooth manner. When closing, the door would not generate loud impact, and the affiliated parts can be better maintained.

Another object of the present disclosure is to open and close the door in a noise-less manner through the door damping apparatus.

According to one exemplary embodiment of the present disclosure, the door damping apparatus is connected to a door and an immobile frame. The door damping apparatus comprises a shaft seat, a shaft, a cylinder, a piston, a spring unit, a check valve and a throttle valve.

The shaft seat is fixed to the immobile frame. The shaft seat includes a housing that defines a shaft hole, a receiving hole, and a fluid passage. The shaft hole and the receiving hole are in communication with each other. The open-ended fluid passage is in communication with the shaft hole and through the receiving hole with the cylinder. The shaft is disposed in the shaft seat in a rotatable manner and connected to the door. Also, the shaft has a positioning recess formed thereon.

The hollow cylinder is disposed in the receiving hole and opens toward the shaft seat. The hollow piston has a fluid outlet formed on one end thereof and is movably disposed in the cylinder, where the reciprocating piston travels in a linear motion. The piston is arranged proximate to the shaft and selectively presses against the positioning recess of the shaft. A reservoir, which stores hydraulic fluid, is formed by the internal space created between the piston and cylinder. The opposite ends of the spring unit press against the cylinder and piston respectively. The check valve is arranged in the reservoir. One end of the throttle valve is arranged proximate to the shaft. Whereas the other end of the throttle valve is inserted into the fluid passage.

In one approach, the spring unit includes a first spring and a second spring. The first and second springs are disposed in the reservoir. One end of the first spring and one end of the second spring are abutted to the cylinder. The other end of the first spring and the other end of the second spring are abutted to the piston.

The check valve includes a valve seat and a closing member. The valve seat is formed with a seat opening thereon. The closing member is disposed on one side of the seat valve and acts as a gate to selectively close the seat opening. The spring unit is abutted to the seat valve.

A pair of bearings is disposed in the shaft seat to support the shaft.

Moreover, the cylinder is formed with a fluid inlet on one side thereof in communication with the fluid passage. The throttle valve is bolted onto the housing of the shaft seat. The throttle valve has a tapered portion formed on one end thereof. The tapered portion extends into the fluid passage and is proximate to the fluid inlet of the cylinder.

The angle of the tapered portion is approximately in the range of 15 to 45 degrees.

Preferably, the shaft seat is fixed to the immobile frame via a first connecting unit. The first connecting unit includes a first plate and a second plate. At least one gasket is disposed between the first and second plates. The first plate is fixed to the shaft seat.

Preferably, the first connecting unit further includes a fastening seat fixed to the shaft seat.

The shaft is connected to the door via a second connecting unit. The second connecting unit includes a third plate and a fourth plate. The door is held between the third and fourth plates.

Preferably, at least one filter is disposed inside the shaft seat. The filter is arranged in the fluid passage and proximate to the throttle valve or in the reservoir and proximate to the check valve.

The present disclosure of the door damping apparatus controls the door closing and opening by the cooperation of the shaft seat, shaft, cylinder, piston, spring unit, check valve and throttle valve. The reservoir is formed internally of the apparatus, and the fluid passage allows hydraulic fluid circulation. When the door self-closes, the piston is moved by the spring unit and returns the fixing surface to the closed position. The spring unit forces the piston to move away from the cylinder and toward the shaft. Meanwhile, the hydraulic fluid between the check valve and the shaft seat will push the closing member against the seat opening so the hydraulic fluid can only go one-way through the fluid outlet into the fluid passage and back to the reservoir. The throttle valve can be adjusted to control the flow in the fluid passage, thus providing the buffer effect to avoid excessive impact when closing the door.

In order to further understand the present disclosure, the following embodiments are provided along with illustrations to facilitate the appreciation of the present disclosure; however, the appended drawings are merely provided for reference and illustration, without any intention to be used for limiting present disclosure.

### BRIEF DESCRIPTION OF THE DRAWINGS

FIG. 1 illustrates an exploded view of a door damping apparatus in accordance with one embodiment of the present disclosure.

FIG. 2 illustrates an assembled view of the door damping apparatus of the present disclosure.

FIG. 3 illustrates a cross sectional view of the door damping apparatus of the present disclosure.

FIG. 4 illustrates an exploded view of a door damping apparatus in accordance with another embodiment of the present disclosure.

FIG. 5 illustrates an assembled view of the door damping apparatus in FIG. 4.

FIG. 6 illustrates a cross sectional view of the door damping apparatus in FIG. 4.

FIG. 7 is a flow chart showing a method of manufacturing the door damping apparatus in accordance with one embodiment of the present disclosure.

FIG. 8 is a flow chart showing a method of manufacturing a door damping apparatus in accordance with another embodiment of the present disclosure.

### DETAILED DESCRIPTION OF THE PREFERRED EMBODIMENTS

The aforementioned illustrations and following detailed descriptions are exemplary for the purpose of further explaining the scope of the present disclosure. Other objectives and advantages related to the present disclosure will be illustrated in the subsequent descriptions and appended drawings.

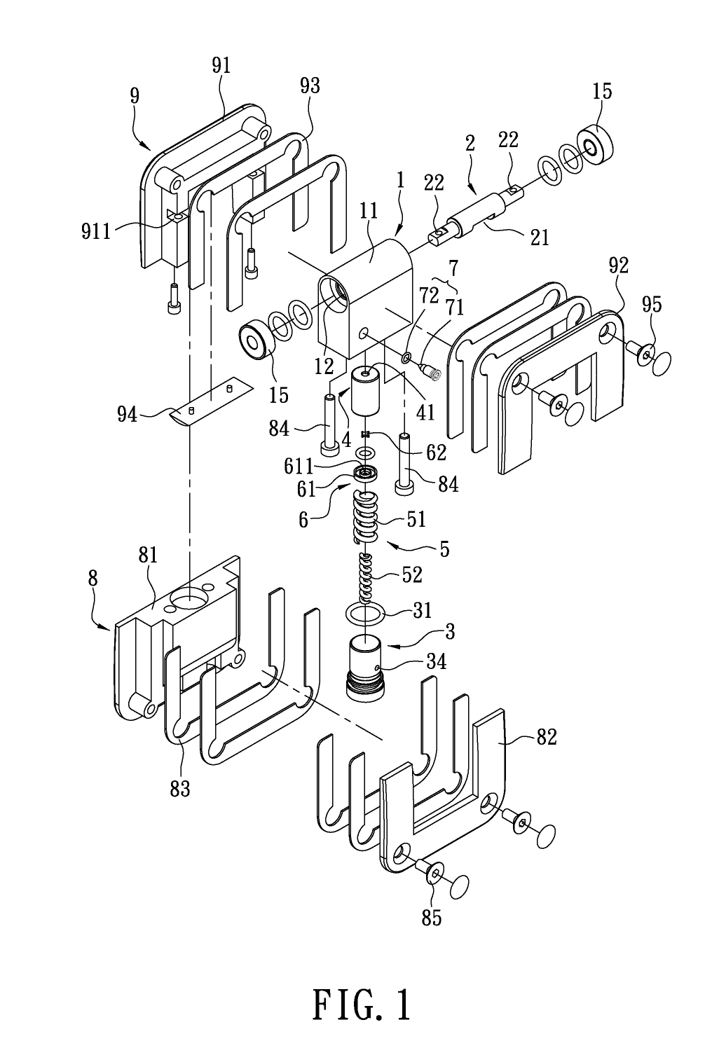

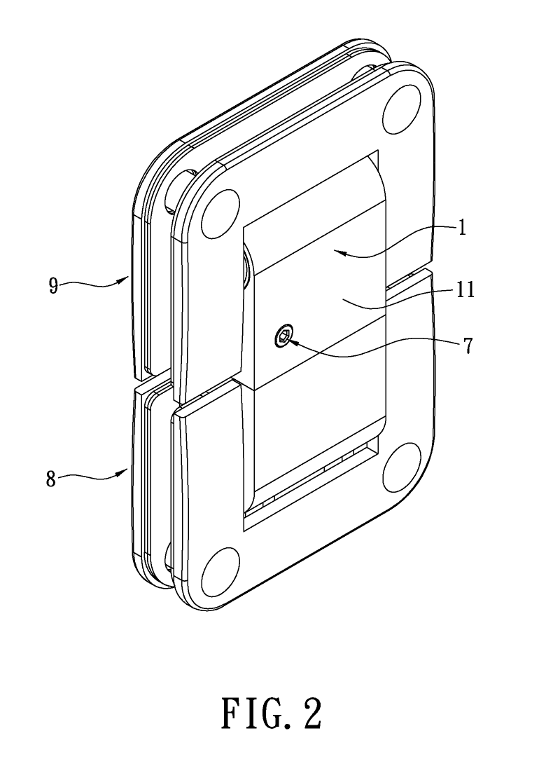

The instant disclosure provides a door damping apparatus, which pivotally connects a door to an immobile frame. The door and frame can be made from conventional materials, for example, glass, iron, steel, and wood, to any shape and size. FIGS. 1, 2 and 3 show the door damping apparatus for the glass door and frame in accordance with an embodiment of the present disclosure.

The door damping apparatus includes a shaft seat 1, a shaft 2, a cylinder 3, a piston 4, a spring unit 5, a check valve 6, a throttle valve 7, a first connecting unit 8, and a second connecting unit 9. The first connecting unit 8 is connected to the shaft seat 1, while the second connecting unit 9 is connected to the shaft 2. The shaft seat 1 is fixed to the immobile frame (e.g., wall, glass frame) by the first connecting unit 8. The first connecting unit 8 includes a first plate 81 and a second plate 82. A plurality of gaskets 83 is disposed between the first and second plates 81, 82. The first plate 81 is mounted on the shaft seat 1 by a pair of fastening elements 84 (e.g., screws). On the other hand, the immobile frame is fixed between the first and second plates 81, 82 by a plurality of fastening elements 85. The utilization of the first and second plates 81, 82 along with the fastening elements 84, 85 securely fixes the shaft seat 1 to the first connecting unit 8. In other words, the shaft seat 1 is secured to the immobile frame via the first connecting unit 8.

The shaft seat 1 has a housing 11 formed with a shaft hole 12 and a receiving hole 13. The shaft hole 12 is projected through the housing 11 from side to side. The receiving hole 13 is open to another side of the housing 11 on one end and passaged to the shaft hole 12 on the opposite end. The housing 11 further defines a fluid passage 14. The fluid passage 14 is defined with two openings respectively in communication with the shaft hole 12 and through the receiving hole 13 with the cylinder 3.

The shaft 2 is disposed in the shaft hole 12. The shaft 2 is supported by a pair of bearings 15 to ensure smooth rotation in the housing 11. In addition, the shaft 2 has a pair of fastening portions 22 formed at opposite ends thereof. The fastening portions 22 extend beyond the shaft seat 1 for engaging the second connecting unit 9.

The second connecting unit 9 includes a third plate 91 and a fourth plate 92. A plurality of gaskets 93 is disposed between the third and fourth plates 91 and 92. The third and fourth plates 91, 92 may clamp to a door (e.g., glass door) by a plurality of fastening elements 95. A sealing pad 94 can be pinned or glued to one end of the third plate 91. This sealing pad 94 is arranged between the shaft seat 1 and the second connecting unit 9 to enhance the sealing effect therebetween. The third plate 91 also defines a pair of fastening grooves 911. The fastening grooves 911 are engageable with the fastening portions 22 of the shaft 2. Thus, the engagement between the fastening portions 22 and the fastening grooves 911 enable the second connecting unit 9 to secure onto the shaft 2. In other words, the second connecting unit 9 is rotatable along with the shaft 2. That is to say, the second connecting unit 9 bridges the shaft 2 to the door, such that the door utilizes the door damping apparatus of the instant disclosure to be pivotally connected to the door frame (e.g., glass frame), for closing and opening the door. Furthermore, a flat fixing surface 21 is formed on the middle portion of the shaft 2 for door (e.g., glass door) rotation purpose. The fixing surface 21 is arranged to face the receiving hole 1.

The cylinder 3 is hollow and axially disposed in the receiving hole 13 of the housing 11. An O-ring 31 is annularly disposed on the cylinder 3 to increase the air-tightness between the cylinder 3 and the receiving hole 13. The cylinder 3 seals one end of the receiving hole 13 and is filled with hydraulic fluid. The cylinder 3 is formed with a fluid inlet 34, which is in communication with the fluid passage 14.

The piston 4 is substantially barrel-shaped having a close end with a fluid outlet 41 formed thereon, with an opposite end being open-ended. The piston 4 has a smaller diameter than the cylinder 3 so is movably disposed therein. In other words, the piston 4 can have linear motion toward or away from the cylinder 3. The interior space formed cooperatively by the cylinder 3 and the piston 4 defines a reservoir 42 for storing hydraulic fluid (not shown). The holed end of the piston 4 abuts to the shaft 2. As the shaft 2 rotates, the fixing surface 21 is selectively abutted by the piston 4.

The spring unit 5 includes at least one spring. For the illustrated embodiment, the spring unit 5 includes a first spring 51 and a second spring 52. The first spring 51 and the second spring 52 are disposed in the reservoir 42. That is to say, the first and second springs 51 and 52 abut to the cylinder 3 on one end and the piston 4 indirectly on the opposite end. By disposing the spring unit 5 in between the cylinder 3 and the piston 4, the piston 4 can be actuated. In other words, the spring unit 5 may urge the piston 4 into abutment elastically with the fixing surface 21 of the shaft 2, such that the spring unit 5 provides the restoring energy for the self-closing door.

The check valve 6 is arranged in the reservoir 42. As long as the check valve 6 can block reverse flow, there is no structural restriction for the check valve 6. The purpose of the check valve 6 is to prevent non-restricted movement of the hydraulic fluid in the reservoir 42. The hydraulic fluid is allowed to flow in one direction only. In this embodiment, the check valve 6 includes a valve seat 61 and a closing member 62. The valve seat 61 is formed with a seat opening 611. The closing member 62 is disposed between the fluid outlet 41 and the valve seat 61 for engaging the seat opening 611. Due to the check valve 6, the hydraulic fluid can only travel in one direction which goes from the reservoir 42 through the seat opening 611 to the fluid outlet 41. When the hydraulic fluid travels in reverse direction, the flow will urge the closing member 62 onto the seat opening 611 therefore sealing the valve seat 61 and blocking reverse flow. The spring unit 5 (first spring 51 and second spring 52) abuts to the valve seat 61 on one end. Thus, the spring force of the spring unit 5 is transmitted by the valve seat 61 to actuate the piston 4.

The throttle valve 7 is disposed on the shaft seat 1. For the illustrated embodiment, the throttle valve 7 is bolted to the housing 11 of the shaft seat 1. Specifically, the throttle valve 7 has a tapered portion 71 on one end rotatably inserted into the housing 11. This tapered portion 71 projects into the fluid passage 14 and is near the fluid inlet 34 of the cylinder 3. Thereby, the throttle valve 71 can be utilized to adjust the flow of the hydraulic fluid and allow different door closing speeds. The opposite end of the throttle valve 7 away from the tapered portion 71 is disposed externally on shaft seat 1. Tools such as a box-end wrench or a screwdriver may be used to manually adjust the throttle valve 7. The throttle valve 7 also includes an O-ring 72 disposed circumferentially on thereon to enhance the sealing effectiveness between the throttle valve 7 and the housing 11. Based on numerous experiments, the angle of the tapered portion 71 preferably ranges from 15 to 45 degrees to best control the flow of hydraulic fluid.

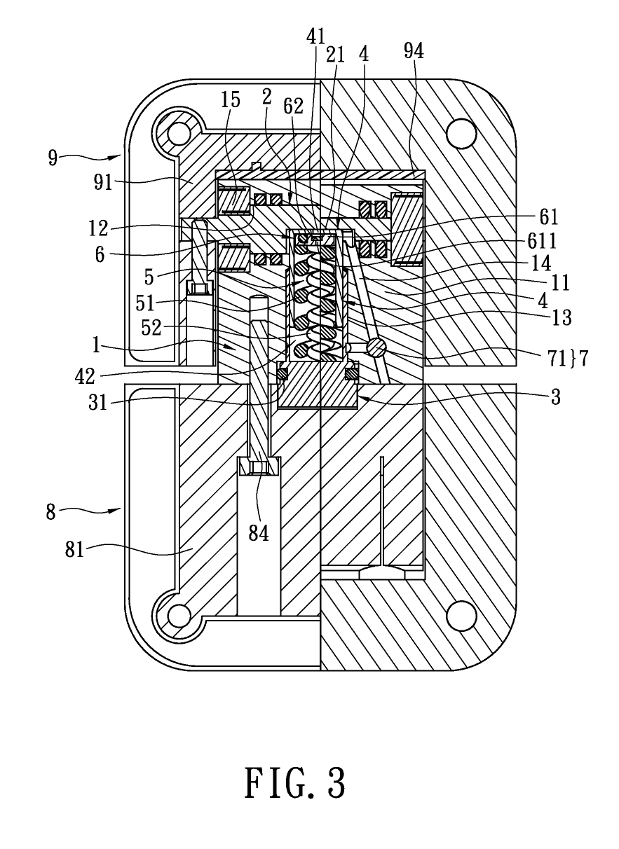

For the instant disclosure, the self-closing actuation is provided by the spring unit 5. FIG. 3 shows the door damping apparatus when the door is closed. At such state, the piston 4 is pushed by the spring unit 5 to abut against the fixing surface 21 of the shaft 2 elastically. When the door (e.g., glass door) is rotatably opening (not shown), the second connecting unit 9 rotates along with the door and enables the shaft 2 to rotate in the shaft hole 12. The rotation of the shaft 2 pushes the piston 4 away from the fixing surface 21 towards the cylinder 3. The spring unit 5 is simultaneously compressed by the piston 4, thus allowing the door to be opened. It should also be noted that as the piston 4 moves toward the cylinder 3, (i.e., along the downward direction based on the orientation of FIG. 3), the capacity of the reservoir 42 is reduced. The hydraulic fluid is forced to exit the reservoir 42 through the seat opening 611. The hydraulic fluid flows substantially in a downward direction (based on the orientation shown in FIG. 3) in the fluid passage 14 without any damping effect. In other words, when the door is being opened, the internal hydraulic fluid of the door damping apparatus does not oppose the operation.

In contrast, when closing the door, the piston 4 is actuated by the elastic force as the spring unit 5 releases. The actuated piston 4 would turn the shaft 2 and abuts the fixing surface 21 as prior to the door being opening. In more detail, the piston 4 is actuated by the spring unit 5 in a direction away from the cylinder 3 (i.e., upward direction). Whereas the reservoir 42 is expanded and filled with the hydraulic fluid via the fluid inlet 34. In other words, the hydraulic fluid of the reservoir 42 can only flow in the direction from the seat opening 611 of the valve seat 61 to the fluid outlet 41 of the piston 4. If the hydraulic fluid flows in a reverse direction, the reverse flow would move the closing member 62 to abut against the seat opening 611 of the valve seat 61 in creating a seal. Thus, backflowing is prevented in achieving the non-return effect. Hence, the hydraulic fluid can only flow in one direction through the fluid passage 14 and back into the reservoir 42. As shown in FIG. 3, the fluid passage 14 is a narrow path, and the throttle valve 7 is disposed in the fluid passage 14. The flow of the hydraulic fluid in the fluid passage 14 can be controlled by the throttle valve 7. When the flow is reduced in the fluid passage 14, the damping effect is greater. The rotation of the shaft 2 is relatively slower. Thus, the door and the second connecting unit 9 can slowly return to the closed position (i.e., door closes). Loud impact can be avoided as the door closes. In contrast, an increase of flow in the fluid passage 14 decreases the door dampening effect. The rotation of the shaft 2 is comparatively quicker. Thus, the door and the second connecting unit 9 would quickly return to the closed position. In other words, the door would close at a faster speed.

The door damping apparatus utilizes the shaft seat 1, the shaft 2, the cylinder 3, the piston 4, and the throttle valve 7 to control the opening and closing of the door. The reservoir 42, the fluid passage 14, the spring unit 5, the check valve 6, and the hydraulic fluid enable the door to be smoothly opened and gently self closes. The opening and closing of the door can be easily controlled. The improved control prevents the door from generating loud impact. In addition, the reservoir 42 and the fluid passage 14 are constructed in a structurally simple manner. Thus, the hydraulic fluid is less likely to generate noise when the fluid pressure changes. The damping apparatus can be operated in a quiet manner.

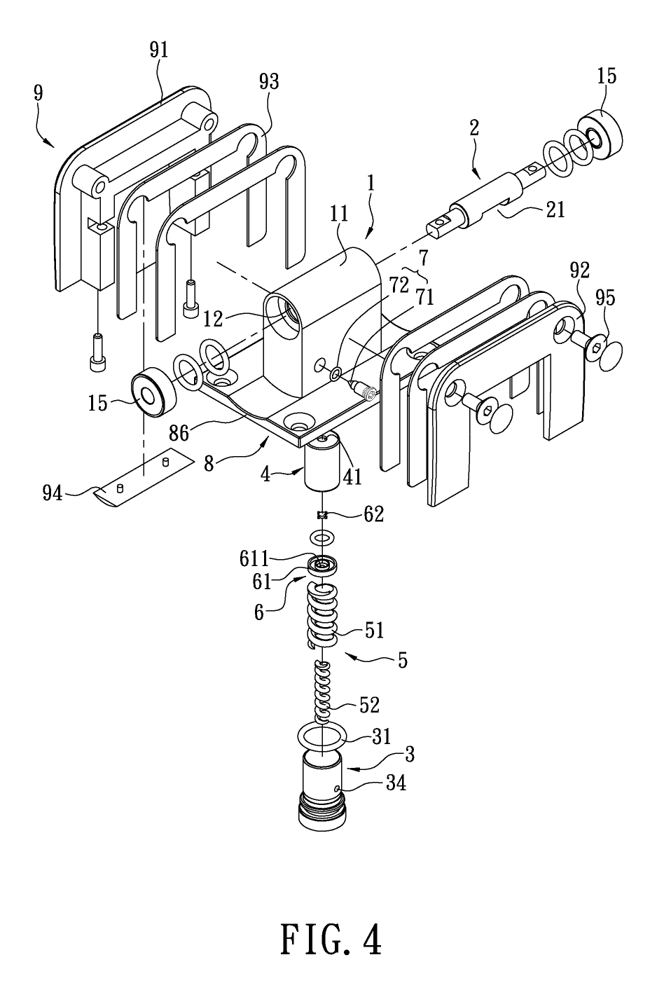

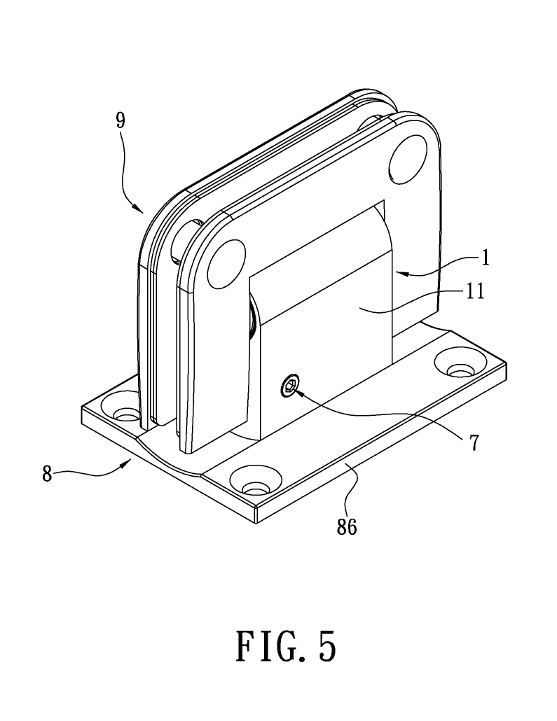

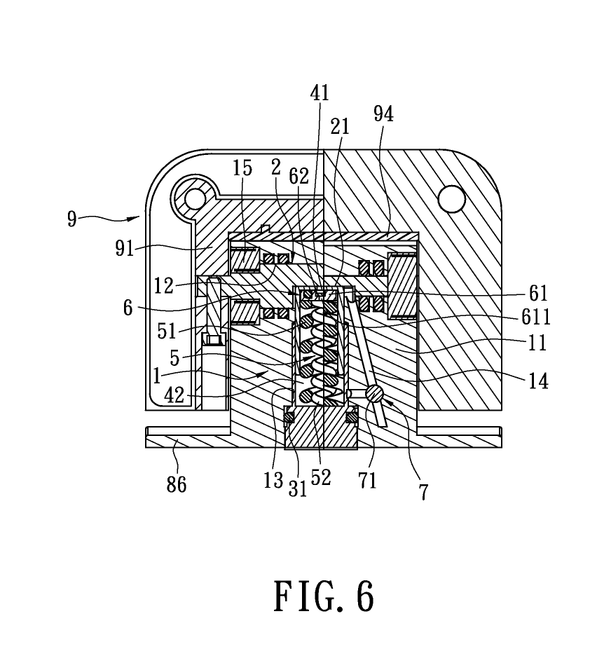

FIGS. 4, 5, and 6 show another embodiment of the present disclosure. This embodiment shows a glass-to-wall door damping apparatus, which pivotally connects a glass door to a wall. For parts identical or similar to the previous embodiment, no further description is provided. The difference between the two embodiments is with the first connecting unit 8. For the instant embodiment, the first connecting unit 8 has a fastening seat 86 engaged to the shaft seat 1. The fastening seat 86 and the shaft seat 1 can also be a one-piece structure. Thus, the shaft seat 1 may be securely mounted onto the immobile frame (i.e., wall) via the first connecting unit 8. In addition, for any one skilled in the art, at least one oil filter (not shown) may be disposed in the shaft seat 1. The oil filter may be disposed in the fluid passage 14 and proximate to the throttle valve 7. Alternatively, the oil filter may be disposed in the reservoir 42 and proximate to the check valve 6. After repetitive usage, the door damping apparatus may accumulate dust and debris in the fluid passage 14 as well as reservoir 42. The filter prevents particles from contaminating or blocking the fluid passage 14 and the reservoir 42, thus extending the lifespan of the door damping apparatus.

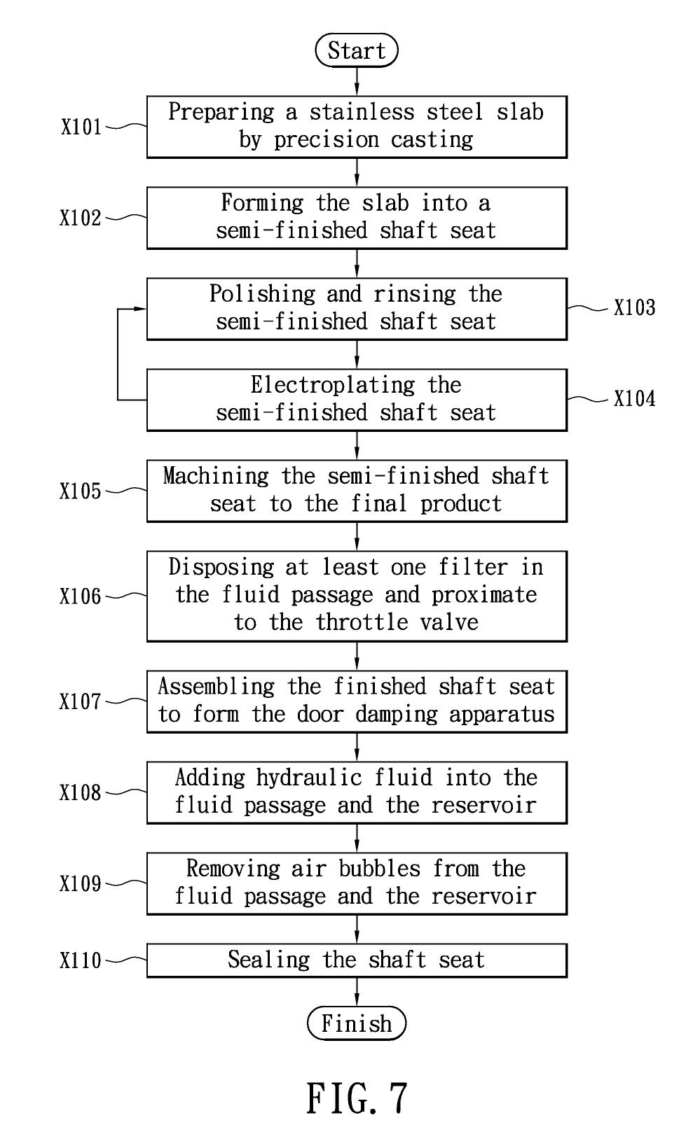

FIG. 7 is a flow chart showing a manufacturing method of the door damping apparatus of the instant disclosure. It should be noted that precision in production is critical to achieve low noise and smooth operation of the damping apparatus. The manufacturing method includes the following steps:

Step X101: preparing a stainless steel slab by precision casting. The slab is preferably made of grade 304 or 316 stainless steel. Both types of stainless steel have higher purity and more uniformed lattice structure.

Step X102: forming the stainless steel slab into a semi-finished shaft seat 1. Typically, the slab is formed into desired shape by means of stamping. The stamping procedure is comparatively fast and suitable for mass production applications. However, to obtain higher accuracy, diamond wire cutting is preferably employed to shape the slab, which also prevents localized stress concentration effect.

Step X103: polishing and rinsing the semi-finished shaft seat 1. The purpose is to remove dusts and debris produced during the forming process off the semi-finished product.

Step X104: electroplating the semi-finished shaft seat 1. The coated material can be copper, nickel, chromium, lead, or tin. For example, if the desired material is copper, the semi-finished shaft seat can be immersed in a copper sulfate bath and supplied with electrical current. Thus, copper can be coated onto the surface of the semi-finished shaft seat 1.

For higher quality and precision, the abovementioned steps X103 and X104 can be performed repeatedly to achieve a desired result. For each plating procedure, different material can be coated onto the semi-finished shaft seat 1. In other words, after repeated plating process, different metal layers are deposited onto the semi-finished shaft seat 1 to attain special properties. Based on test results, by repeat steps X103 and X104 once, the finished product would meet the precision requirement.

Step X105: machining the semi-finished shaft seat 1 to the final product. The machining process may be lathing, milling, or diamond wire cutting.

Step X106: disposing a filter in the fluid passage 14 and proximate the throttle valve 7. The filter can prevent the dust and debris from contaminating the fluid passage 14 or the reservoir 42 and blocking the throttle valve 7. A blocked throttle valve 7 may result in the failure of flow control.

Step X107: assembling the finished shaft seat 1 and other parts to form the door damping apparatus (as shown in FIGS. 1 and 4).

Step X108: adding hydraulic fluid into the fluid passage 14 and the reservoir 42.

Step X109: removing air bubbles from the fluid passage 14 and the reservoir 42. When air bubbles are present in the fluid passage 14 and the reservoir 42, the closing of the door will easily cause noise as the fluid pressure changes. Therefore, complete removal of the air bubbles are very critical to allow the apparatus to operate in a quiet manner. A preferable method to remove air bubbles is ultrasonic vibration.

Step X110: sealing the shaft seat 1. After air bubbles in the fluid passage 14 and the reservoir 42 have been removed, the shaft seat 1 can be welded for sealing. Alternative, adhesives can be applied to generate the same effect. Thus, leakage of the hydraulic fluid can be prevented, and air would not be able to enter the fluid passage 14 and the reservoir 42.

The above described manufacturing method can be utilized to manufacture the door damping apparatus of the instant disclosure, which is of high-quality, air-tight, and has an extended service life. The apparatus can facilitate the opening and closing of the door and operate in a quiet manner.

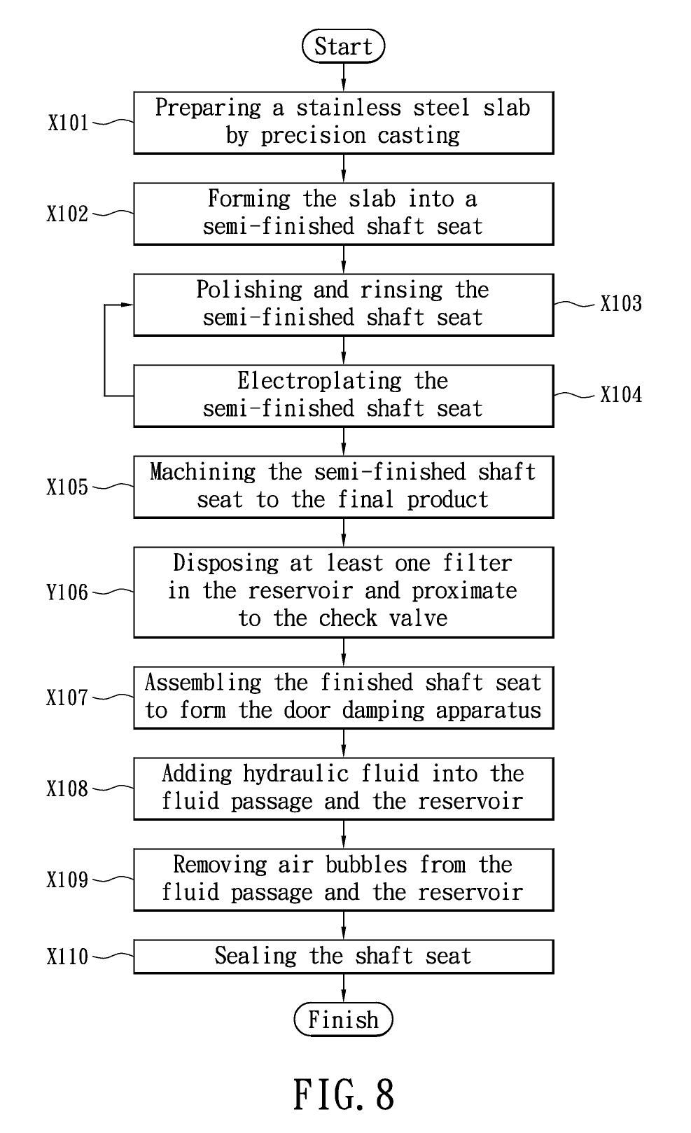

In addition, FIG. 8 shows another embodiment of a manufacturing method for the door damping apparatus. The manufacturing steps in FIG. 8 are identical with FIG. 7 except step Y106, which replaces step X106 in FIG. 7. In other words, after the semi-finished shaft seat 1 has been machined to the final product, the filter is disposed in the reservoir 42 and proximate to the check valve 6. Namely, the filter is arranged on opposite sides of the check valve 6. Thus, the closing member 62 and the seat opening 611 of the check valve 6 are protected against blockage due to debris or contaminants in the hydraulic fluid. The manufacturing steps illustrated in FIG. 8 can be utilized to achieve the aforementioned advantages of the door damping apparatus of the instant disclosure.

The descriptions illustrated supra set forth simply the preferred embodiments of the present disclosure; however, the characteristics of the present disclosure are by no means restricted thereto. All changes, alternations, or modifications conveniently considered by those skilled in the art are deemed to be encompassed within the scope of the present disclosure delineated by the following claims.

What is claimed is:

1. A door damping apparatus connecting a door and an immobile frame, comprising:
a shaft seat fixed to the immobile frame, the shaft seat including a housing that defines a shaft hole, a receiving hole, and a fluid passage, wherein the shaft hole and the receiving hole are in communication with each other, and opposite ends of the fluid passage are respectively connected to the shaft hole and the receiving hole;
a shaft connected to the door and rotatably disposed in the shaft hole, wherein the shaft has a fixing surface formed thereon;
a cylinder disposed in the receiving hole of the housing;
a piston defining a fluid outlet on one end thereof, the piston being movably disposed in the cylinder to form a reservoir for storing hydraulic liquid, wherein the piston is arranged in proximate to the shaft and selectively abuts the fixing surface;
a spring unit disposed in the reservoir, wherein opposite ends of the spring unit respectively abuts to the cylinder and the piston;
a check valve disposed in the reservoir; and
a throttle valve with one end thereof disposed externally of the shaft seat and another end thereof extending into the fluid passage.

2. The door damping apparatus according to claim 1, wherein the spring unit includes a first spring and a second spring, wherein the first and second springs are disposed in the reservoir, and wherein one end of the first and second springs abuts to the cylinder and another end of the first and second springs abuts to the piston.

3. The door damping apparatus according to claim 1, wherein the check valve includes a valve seat and a closing member, wherein the valve seat defines a seat opening engageable by the closing member, and wherein the spring unit abuts to the valve seat.

4. The door damping apparatus according to claim 1, wherein a bearing is disposed in the housing and supports the shaft.

5. The door damping apparatus according to claim 1, wherein the cylinder defines a fluid inlet that communicates with the fluid passage, wherein the throttle valve is bolted to the housing, and wherein one end of the throttle valve has a tapered portion extending into the fluid passage and proximate to the fluid inlet.

6. The door damping apparatus according to claim 5, wherein the angle of the tapered portion is approximately in the range of 15 to 45 degrees.

7. The door damping apparatus according to claim 1, wherein the shaft seat is fixed to the immobile frame by a first connecting unit, wherein the first connecting unit includes a first plate and a second plate, wherein at least one gasket is disposed between the first and second plates, and wherein the first plate is fixed to the shaft seat.

8. The door damping apparatus according to claim 1, wherein the shaft seat is fixed to the immobile frame by a first connecting unit, and wherein the first connecting unit has a fastening seat fixed to the shaft seat.

9. The door damping apparatus according to claim 1, wherein the shaft connects to the door by a second connecting unit, wherein the second connecting unit includes a third plate and a fourth plate, wherein the door is held between the third and fourth plates.

10. The door damping apparatus according to claim 1, further comprising at least one filter disposed in the shaft seat, wherein the filter is disposed in the fluid passage and proximate to the throttle valve.

11. The door damping apparatus of claim 1, further comprising at least one filter disposed in the shaft seat, wherein the filter is disposed in the reservoir and proximate to the check valve.

12. A manufacturing method of door damping apparatus that defines a fluid passage and a reservoir for storing hydraulic fluid, comprising the step of:
preparing a stainless steel slab by precision casting;
forming the slab into a semi-finished shaft seat;
polishing and rinsing the semi-finished shaft seat;
electroplating the semi-finished shaft seat;
machining the semi-finished shaft seat to the final product;
assembling the finished shaft seat to form the door damping apparatus;
adding hydraulic fluid into the fluid passage and the reservoir;
removing air bubbles from the fluid passage and the reservoir;
sealing the shaft seat.

13. The manufacturing method of door damping apparatus according to claim 12, wherein the polishing, rinsing, and electroplating procedures are repeated at least once.

14. The manufacturing method of door damping apparatus according to claim 12, wherein the semi-finished shaft seat is electroplated by immersing in a copper sulfate bath.

15. The manufacturing method of door damping apparatus according to claim 12, wherein different metallic layers are plated onto the semi-finished shaft seat.

16. The manufacturing method of door damping apparatus according to claim 15, wherein at least one material selected from copper, nickel, chromium, lead, and tin is plated on the semi-finished shaft seat.

17. The manufacturing method of door damping apparatus according to claim 12, wherein the machining procedure is selected from a group consisting of lathing, milling, and diamond wire cutting.

18. The manufacturing method of door damping apparatus according to claim 12, further comprising the step of disposing at least one filter in the fluid passage and proximate to the throttle valve.

19. The manufacturing method of door damping apparatus according to claim 12, further comprising the step of disposing at least one filter in the reservoir and proximate to the check valve.
